(19) United States
(12) Patent Application Publication
(10) Pub. No.: US 2019/0283542 A1
(43) Pub. Date: Sep. 19, 2019

(54) REFRIGERANT SYSTEM FOR AUTOMOTIVE AIR CONDITIONER

(71) Applicant: Air International Thermal Systems, Auburn Hills, MI (US)

(72) Inventor: Joseph J. Spryshak, Hartland, MI (US)

(73) Assignee: Air International Thermal Systems, Auburn Hills, MI (US)

(21) Appl. No.: 16/357,210

(22) Filed: Mar. 18, 2019

Related U.S. Application Data
(60) Provisional application No. 62/644,434, filed on Mar. 17, 2018.

(51) Int. Cl. B60H 1/32

(52) U.S. Cl. CPC B60H 1/3222

(57) ABSTRACT

A storage evaporator for an air conditioning system in a vehicle includes a single, unified coolant component unit which includes the coolant condenser, the compressor, and the chiller. Four coolant connections and two electrical connections are provided between the unified coolant component unit and the rest of the air conditioning system. Two of the four coolant connections are made with the coolant condenser, with one connection being provided to have coolant flow into the condenser and the other being provided to have coolant flow out of the condenser. Two of the four coolant connections are made with the chiller, with one connection being provided to have coolant flow into the chiller and the other being provided to have coolant flow out of the chiller. The two electrical connections are associated with the compressor which is an electric compressor. The electrical connections are high voltage and control lines.

### CROSS-REFERENCE TO RELATED APPLICATION

This application claims the benefit under 35 U.S.C. Section 119(e) of U.S. provisional application Ser. No. 62/644,434, filed Mar. 17, 2018, which is incorporated by reference herein in its entirety.

### TECHNICAL FIELD

The disclosed inventive concept relates to air conditioning systems for automotive vehicles. More particularly, the disclosed inventive concept relates to a refrigerant system for an automotive vehicle in which the coolant condenser, the compressor, and the chiller are provided within a single housing that forms a unified coolant component unit. Connections between the unified coolant component unit housing the coolant condenser, the compressor, and the chiller are made to the cooling system. The disclosed inventive concept eliminates refrigerant connections and refrigerant path switching valves while eliminating refrigerant plumbing. Because the coolant condenser, the compressor, and the chiller are provided within an housing, the risk of leakage is minimized or is eliminated altogether.

### BACKGROUND OF THE INVENTION

Most vehicles today include air conditioning systems to provide for improved occupant comfort. While being first introduced in the automotive world several decades ago, air conditioning systems have fundamentally changed very little. Thus the fundamental parts of the modern vehicle's air conditioning system are known and understood. These parts include the compressor, the condenser, the evaporator, the thermal expansion valve, the drier or accumulator, and an array of fluid and electrical connecting lines. In many ways the compressor is the heart of the vehicle's air conditioning system. The compressor pressurizes hot gaseous refrigerant and forces it on to the condenser. The condenser, which is similar to a small radiator, cools the hot gases received from the compressor. As these gases cool, they become liquid in the condenser.

Liquid refrigerant leaves the condenser under high pressure and enters the drier or accumulator. The drier catches any liquid water that may inadvertently have entered the system. The liquid refrigerant, once cleared of any water, flows to the expansion valve which functions to remove pressure from the liquid refrigerant and literally allows it to expand. This reduction of pressure allows the liquid refrigerant to return to the vapor stage in the evaporator, the refrigerant's next stop.

The evaporator is also similar in shape and function to a small radiator. Typically the evaporator is fitted inside of the vehicle's passenger compartment in or around the instrument panel. The still-liquid refrigerant enters the evaporator under low pressure from the expansion valve. The liquid refrigerant vaporizes while absorbing heat from inside the car. Cold air is circulated within the passenger compartment by a fan that pushes air across the fins of the evaporator. Low pressure refrigerant, now in gaseous form, exits the evaporator and returns to the compressor where the cycle is repeated.

While basically providing the needed functionality and performance, known air conditioning systems face certain difficulties. Refrigerant plumbing, including lines and fittings, is extensive and is often prone to leakage, particularly as the vehicle ages. Failed refrigerant plumbing is particularly problematic in cold environments where salt is frequently used on roadways because of the corrosive effects of salt. Failure due to age or corrosion is often associated with refrigerant high pressure lines. Leaking refrigerant lines present an environmental hazard as well as great repair cost.

Maintenance of known air conditioning systems can also be difficult due to the placement of system components around the drive belt and the engine. Not only does the array of components of the conventional air conditioning system create system maintenance problems, the array also interferes with non-air conditioning system vehicle maintenance, particularly engine maintenance.

Accordingly, as in so many areas of automotive vehicle technology, there is room for improvement in the air conditioning system of the modern automotive vehicle.

### SUMMARY OF THE INVENTION

The disclosed inventive concept overcomes the problems associated with known automotive air conditioning systems by providing a system whereby the coolant condenser, the compressor, and the chiller are provided within a single housing that forms a unified coolant component unit. According to this arrangement, four coolant connections and two electrical connections are provided between the unified coolant component unit and the rest of the air conditioning system. Two of the four coolant connections are made with the coolant condenser, with one connection being provided to have coolant flow into the condenser and the other being provided to have coolant flow out of the condenser. Two of the four coolant connections are made with the chiller, with one connection being provided to have coolant flow into the chiller and the other being provided to have coolant flow out of the chiller. The two electrical connections are associated with the compressor which, according to the disclosed inventive concept, is an electric compressor. The electrical connections are high voltage and control lines.

The housed coolant condenser, compressor, and chiller advantageously can operate on glycol instead of conventional air conditioner refrigerant, thereby not only reducing risk to the environment but also lowering costs associated with the coolant. The disclosed inventive concept provides several other advantages over known air conditioning systems related to the reduced number of components, such as switching valves and associated refrigerant plumbing, thus reducing material, assembly, and repair costs.

The above advantages and other advantages and features will be readily apparent from the following detailed description of the preferred embodiments when taken in connection with the accompanying drawings.

### BRIEF DESCRIPTION OF THE DRAWING

For a more complete understanding of this invention, reference should now be made to the embodiments illustrated in greater detail in the accompanying drawing and described below by way of examples of the invention wherein:

FIG. 1 is a diagrammatic view of a unified coolant component unit shown in relation to four coolant connections and two electrical connections according to the disclosed inventive concept.

### DETAILED DESCRIPTION OF THE PREFERRED EMBODIMENT

In the following description, various operating parameters and components are described for different constructed embodiments. These specific parameters and components are included as examples and are not meant to be limiting.

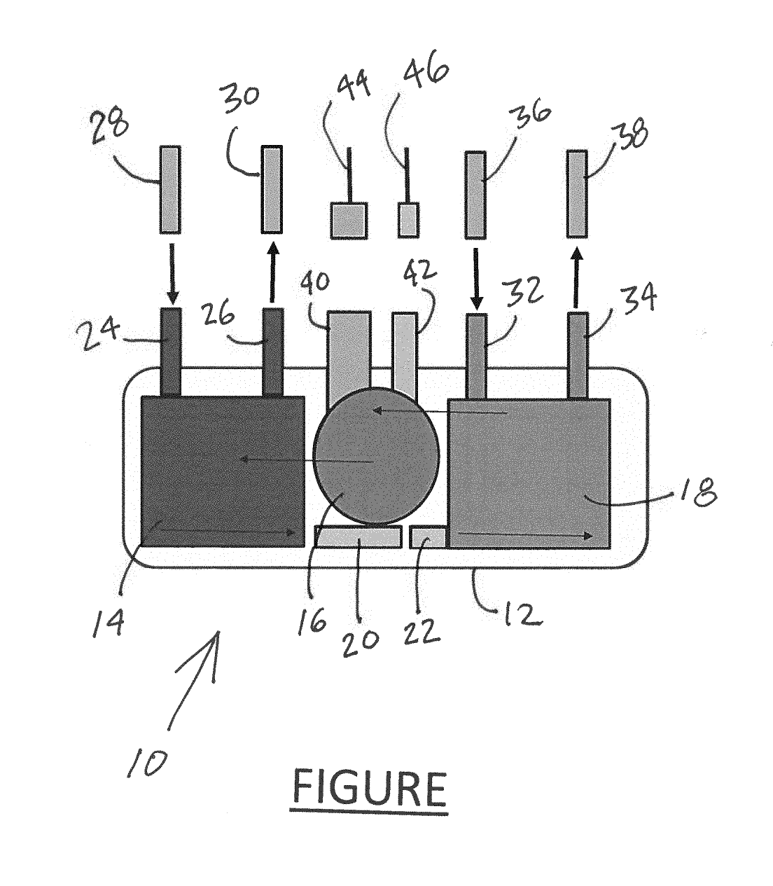

The air conditioning system for a vehicle according incorporating the unified coolant component unit according to the disclosed inventive concept is generally illustrated in FIG. 1. However, it is to be understood that the illustrated embodiments are suggestive and are not intended as being limiting.

The disclosed inventive concept provides an improvement over known air conditioning systems through the use of a single, unified coolant component unit in which the coolant condenser, the compressor, and the chiller are housed, thereby reducing the number of fluid lines while at the same time making the vehicle more environmentally friendly. The unified coolant component unit according to the disclosed inventive concept replaces the conventional condenser with a coolant low temperature radiator. The refrigerant plumbing and associated packaging are entirely eliminated, while providing instead a single packaged component. The overall cooling system is thus compactly integrated, thereby reducing not only system complexity, but also system component cost, assembly time, and repair fees. The unified coolant component unit thus eliminates the need for refrigerant plumbing and associated refrigerant paths and switch valves, thus reducing overall cost while improving system reliability and increasing service simplicity.

With particular attention to reliability, the unified coolant component unit according to the disclosed inventive concept significantly reduces the risk of leakage rate insofar as it has no mechanical plumbing seals given the brazing of all components. The compressor housing and shaft seal provide the only possible source of leakage. Furthermore, the oil circulation rate (OCR) is robust due to the presence of only a single loop without dead plumbing legs.

With particular attention to service simplicity, the unified coolant component unit is provided as a single, replaceable component, and thus may be readily replaced as a single unit with a single part number. Importantly, the steps of recovery or recharging of refrigerant are eliminated during servicing. High pressure carbon dioxide is also not a concern during servicing.

The disclosed inventive concept also provides a significant advantage to the reduction of global warming. Environmentally, it is understood that carbon dioxide has a greatest global warming potential (GWP) of 1. The newer refrigerants, such as R-1234yf, demonstrate a GWP of less than 1, which compares favorably to carbon dioxide and very favorably to R-134a, which has a GWP of 1.43.

However, glycol provides the optimum solution, both environmentally and commercially, though its use has generally been limited to a heat transfer system. Glycol does change phases as it gains or loses heat energy. Generally inert to all common piping, glycol is nontoxic and has no GWP. Glycol is also an efficient coolant given its almost instant temperature pull down. The disclosed inventive concept includes the use of glycol as opposed to conventional refrigerants, thus providing a significant environmental advantage.

The use of glycol also offers control advantages in that it operates under lower pressure than refrigerant and is of a lower cost than refrigerant. The use of glycol as opposed to refrigerant also allows the use of more simple, lighter, and more robust control valves and pumps, thereby further reducing overall production, operating, and maintenance and repair costs.

Turning to the FIGURE, a unified coolant component unit is shown and is generally illustrated as 10. The unified coolant component 10 includes a housing 12. Contained within the housing 12 are a coolant condenser 14, an electric compressor 16, and a chiller 18. Also contained within the housing 12 is a receiver dryer 20 fluidly associated with the coolant condenser 14 and the electric compressor 16. A thermal expansion valve 22 is fluidly associated with the chiller 18 and the receiver dryer 20. Each of the coolant condenser 14, the electric compressor 16, the chiller 18, the receiver dryer 20, and the thermal expansion valve 22 is entirely contained within the housing 12.

Two coolant connections 24 and 26 are fluidly connected with the coolant condenser 14. The coolant connections 24 and 26 are also fluidly connected respectively with a first line 28 and a second line 30 of the vehicle's air conditioning system. The coolant connection 24 provides coolant flow into the coolant condenser 14 while the coolant connection 26 provides coolant flow out of the coolant condenser 14.

Two coolant connections 32 and 34 are fluidly connected with the chiller 18. The coolant connections 32 and 34 are also fluidly connected respectively with a third line 36 and a fourth line 38 of the vehicle's air conditioning system. The coolant connection 32 provides coolant flow into the chiller 18 while the coolant connection 34 provides coolant flow out of the chiller 18.

Two electrical connections 40 and 42 are also provided to deliver high voltage and control currents to the electric compressor 16. The electrical connections 40 and 42 are connected respectively with a first electrical connection 44 and a second electrical connection 46 of the vehicle's electrical system.

While the preferred embodiments of the disclosed inventive concept have been discussed are shown in the accompanying drawings and are set forth in the associated description, one skilled in the art will readily recognize from such discussion, and from the accompanying drawings and claims that various changes, modifications and variations can be made therein without departing from the true spirit and fair scope of the invention as defined by the following claims.

What is claimed is:

1. A unified coolant component unit for use with a vehicle air conditioning system, the unit comprising:
a housing;
a coolant condenser contained within said housing, said coolant condenser having coolant connections;
a compressor contained within said housing; and
a chiller contained within said housing, said chiller having coolant connections.

2. The unified coolant component unit of claim 1, wherein said compressor is an electric compressor.

3. The unified coolant component unit of claim 2, further including electrical connections for said electric compressor.

4. The unified coolant component unit of claim 1, wherein said coolant connections include a coolant connection to provide fluid flow into said coolant condenser and a coolant connection to provide fluid flow out of said coolant condenser.

5. The unified coolant component unit of claim 1, wherein said coolant connections include a coolant connection to provide fluid flow into said chiller and a coolant connection to provide fluid flow out of said chiller.

6. A unified coolant component unit for use with a vehicle air conditioning system, the unit comprising:
a housing;
a coolant condenser contained within said housing;
a compressor contained within said housing; and
a chiller contained within said housing.

7. The unified coolant component unit of claim 6, wherein said compressor is an electric compressor.

8. The unified coolant component unit of claim 7, further including electrical connections for said electric compressor.

9. The unified coolant component unit of claim 6, further including coolant connections for said coolant condenser.

10. The unified coolant component unit of claim 9, wherein said coolant connections include a coolant connection to provide fluid flow into said coolant condenser and a coolant connection to provide fluid flow out of said coolant condenser.

11. The unified coolant component unit of claim 6, further including coolant connections for said chiller.

12. The unified coolant component unit of claim 11, wherein said coolant connections include a coolant connection to provide fluid flow into said chiller and a coolant connection to provide fluid flow out of said chiller.

13. An air conditioning system for a vehicle comprising:
coolant lines for conveyance of a cooling fluid;
a unified coolant component unit including
a housing;
a coolant condenser contained within said housing;
a compressor contained within said housing; and
a chiller contained within said housing.

14. The air conditioning system of claim 13, wherein said cooling fluid is glycol.

15. The air conditioning system of claim 13, further including an electrical circuit.

16. The air conditioning system of claim 15, wherein said compressor is an electric compressor.

17. The air conditioning system of claim 16, further including electrical connections between said electric compressor and said electrical circuit.

18. The air conditioning system of claim 13, further including coolant connections between said coolant condenser and said coolant lines, said coolant connections including a first coolant connection to provide fluid flow into said coolant condenser and a second coolant connection to provide fluid flow out of said coolant condenser.

19. The air conditioning system of claim 13, further including coolant connections between said chiller and said coolant lines, said coolant connections including a first coolant connection to provide fluid flow into said chiller and a second coolant connection to provide fluid flow out of said chiller.

20. The air conditioning system of claim 13, further including a receiver dryer fluidly associated with said coolant condenser and a thermal expansion valve fluidly associated with said chiller, said receiver dryer and said thermal expansion valve being contained within said housing.
